(19) United States
(12) Patent Application Publication
(10) Pub. No.: US 2013/0131206 A1
(43) Pub. Date: May 23, 2013

(54) METHOD FOR PRODUCING FLAT, HYDROPHILIC, ALIPHATIC POLYURETHANE FOAMS

(71) Applicants: Meike Niesten, Koln (DE); Sebastain Dörr, Dusseldorf (DE); Thorsten Krämer, Langenfeld (DE)

(72) Inventors: Meike Niesten, Koln (DE); Sebastain Dörr, Dusseldorf (DE); Thorsten Krämer, Langenfeld (DE)

(21) Appl. No.: 13/806,363

(22) PCT Filed: Jun. 20, 2011
(86) PCT No.: PCT/EP2011/060181

§ 371 Date: Jan. 29, 2013

(30) Foreign Application Priority Data
Jun. 22, 2010 (EP) 10166832.5

(51) Int. Cl. B32B 37/15; C08J 9/00

(52) U.S. Cl. CPC B32B 37/15; C08J 9/00
USPC 521/170; 156/60

(57) ABSTRACT

The invention relates to a method for producing flat, hydrophilic, aliphatic polyurethane foams. The invention also relates to a flat, hydrophilic, aliphatic polyurethane foam obtained according to said method and to the use thereof as a wound dressing, incontinence product or cosmetic article. According to the invention, a prepolymer-component and a carbonic acid or carboxylate component containing water is produced, said components are combined and mixed, and the obtained mixture is applied to a flat substrate as a layer which has an even thickness. Directly after application, a perforated separation element is applied in a flat manner to the layer. Said applied layer then expands with the applied perforated separation element to form the flat polyurethane foam.

The invention relates to a method for producing sheetlike hydrophilic aliphatic polyurethane foams. The invention also relates to a sheetlike hydrophilic aliphatic polyurethane foam obtainable according to said method and to the use of said foam as wound dressing, incontinence product or cosmetic article.

European patent application EP 2 143 744 discloses a method which can be used to produce hydrophilic aliphatic polyurethane foams. The method comprises reacting isocyanate-functional prepolymers with C₈- to C₂₂-monocarboxylic acids or their ammonium or alkali metal salts or C₁₂- to C₄₄-dicarboxylic acids or their ammonium or alkali metal salts and water. The prepolymers are obtainable by reacting low molecular weight aliphatic diisocyanates with polyalkylene oxides. The components are mixed and introduced into a beaker in which the foaming reaction then takes place. A slabstock polyurethane foam is obtained. It is cut to the desired thickness of typically 10μ to 5 cm when it is to be used as wound dressing for example.

This method is disadvantageous in that it generates appreciable amounts of cutting waste, which have to be disposed of Furthermore, cutting itself is associated with appreciable practical difficulties in relation to this class of materials. For instance, the foam is quick to tear on cutting. It is also difficult to obtain a uniform thickness of layer.

The as yet unpublished European patent application numbered EP 09009202.4 describes a method for producing sheetlike hydrophilic aliphatic polyurethane foams wherein foam mixtures of the type described above are applied to a substrate by blade coating in order to obtain foams having a uniform thickness of layer.

This method is disadvantageous in that the foam forms a skin on the air side. This skin makes the foam stiff and thereby impairs its drapability, i.e., its ability to conform sheetlike to certain parts of the body. Yet drapability is an important property especially for wound dressings and incontinence products.

The problem addressed by the invention was therefore that of providing a quick, simple and material-efficient method for producing sheetlike hydrophilic aliphatic polyurethane foams having a constant thickness in the range from 1 to 20 mm wherein foams having a homogeneous, skinless surface are obtained.

This problem is solved by the method of claim 1, which comprises
I) preparing isocyanate-functional prepolymers A) by reaction of
   low molecular weight aliphatic diisocyanates A1) having a molar mass of 140 to 278 g/mol with
   di- to hexafunctional polyalkylene oxides A2) having an OH number of 22.5 to 112 mg KOH/g and an ethylene oxide fraction of 50 to 100 mol %, based on the total amount of oxyalkylene groups present,
II) mixing C8- to C22-monocarboxylic acids or their ammonium or alkali metal salts or C12- to C44-dicarboxylic acids or their ammonium or alkali metal salts B) with water C),
III) the mixtures of steps I) and II) being combined and commixed,
IV) applying the mixture of step III) to a sheetlike substrate as a layer of constant thickness,
V) applying an apertured release element to the layer of step IV) in a sheetlike manner, so that the substrate-remote surface of the layer is covered,
VI) expanding the layer of step V) to the foam to be produced.

The isocyanate-functional prepolymers A) are typically prepared by reacting one equivalent of polyols component A2) with 1 to 20 mol, preferably with 1 to 10 mol 2 5 and more preferably with 5 to 10 mol of low molecular weight aliphatic diisocyanate A1).

The reaction can be carried out in the presence of urethanization catalysts such as tin compounds, zinc compounds, amines, guanidines or amidines, or in the presence of allophanatization catalysts such as zinc compounds.

The reaction temperature is typically in the range from 25 to 140° C. and preferably in the range from 60 to 100° C.

When excess isocyanate has been used, excess low molecular weight aliphatic diisocyanate is subsequently removed, preferably by thin film distillation.

Before, during and after the reaction or distillative removal of excess diisocyanate, acidic or alkylating stabilizers, such as benzoyl chloride, isophthaloyl chloride, methyl tosylate, chloropropionic acid, HCl or antioxidants, such as di-tert-butylcresol or tocopherol can be added.

Examples of low molecular weight aliphatic diisocyanates of component A1) are hexamethylene diisocyanate (HDI), isophorone diisocyanate (IPDI), butylene diisocyanate (BDI), bisisocyanatocyclohexylmethane (HMDI), 2,2,4-trimethylhexamethylene diisocyanate, bisisocyanatomethylcyclohexane, bisisocyanatomethyltricyclodecane, xylene diisocyanate, tetramethylxylylene diisocyanate, norbornane diisocyanate, cyclohexane diisocyanate or diisocyanatododecane, of which hexamethylene diisocyanate (HDI), isophorone diisocyanate (IPDI), butylene diisocyanate (BDI) and bis(isocyanatocyclohexyl)methane (HMDI) are preferable. Hexamethylene diisocyanate, isophorone diisocyanate and butylene diisocyanate are more preferable and hexamethylene diisocyanate and isophorone diisocyanate are most preferable.

It is also preferable when the diisocyanate A1) used is exclusively hexamethylene diisocyanate and isophorone diisocyanate or mixtures thereof.

The polyalkylene oxides A2) are preferably copolymers of ethylene oxide and propylene oxide which were started on polyols or amines and have an ethylene oxide content, based on the total amount of oxyalkylene groups present, of 50 to 100 mol % and preferably of 60 to 85 mol %. Suitable starter molecules of this kind are glycerol, trimethylolpropane (TMP), sorbitol, pentaerythritol, triethanolamine, ammonia or ethylenediamine.

The polyalkylene oxides A2) typically have number-average molecular weights of 1000 to 15 000 g/mol and preferably of 3000 to 8500 g/mol.

The polyalkylene oxides A2) may further have OH functionalities of 2 to 6, preferably of 3 to 6 and more preferably of 3 to 4.

In a further development of the invention, the polyalkylene oxides A2) used are copolymers of ethylene oxide and propylene oxide having an ethylene oxide content, based on the total amount of oxyalkylene groups present, of 60 to 85 mol % and started on polyols or amines.

The prepolymers A) used preferably have a residual monomer content of below 1.0 wt % and more preferably of below 0.5 wt %, based on the prepolymer. This content can be achieved through appropriately chosen starting quantities of A1) and A2). However, preference is given to using the isocyanate A1) in excess and the subsequent, preferably distillative, removal of unconverted monomers.

The NCO content of isocyanate-functional prepolymers A) is preferably in the range from 1.5 to 4.5 wt %, more preferably in the range from 1.5 to 3.5 wt % and most preferably in the range from 1.5 to 3.0 wt %.

Component B) utilizes ammonium and alkali metal salts of C₈- to C₂₂-monocarboxylates or their free carboxylic acids or ammonium and alkali metal salts of C₁₂- to C₄₄-dicarboxylates or their free dicarboxylic acids, preferably potassium or sodium salts of C₈- to C₂₂-monocarboxylates or C₁₂- to C₄₄-dicarboxylates and more preferably sodium salts of C₈- to C₂₂-monocarboxylates.

Examples of suitable compounds of component B) are the ammonium, sodium, lithium or potassium salts of ethylhexanoic acid, octanoic acid, decanoic acid, dodecanoic acid, palmitic acid, stearic acid, the octadecenoic acids, the octadecadienoic acids, the octadecatrienoic acids, isostearic acid, erucic acid, abietic acid and hydrogenation products thereof. Examples of C₁₂- to C₄₄-dicarboxylic acids and the ammonium and alkali metal salts derived therefrom are dodecanedioic acid, dodecenylsuccinic acid, tetradecenylsuccinic acid, hexadecenylsuccinic acid, octadecenylsuccinic acid, C₃₆ and C₄₄ dimer fatty acids and hydrogenation products thereof and also the corresponding ammonium, sodium, lithium or potassium salts of these dicarboxylic acids.

The water to be used as component C) can be used as such, as water of crystallization of a salt, as solution in a dipolar aprotic solvent or else as an emulsion. Preferably, the water is used as such or in a dipolar aprotic solvent.

In a preferred embodiment of the invention, the prepolymers A) are mixed in step I) with heterocyclic 4-ring or 6-ring oligomers D) of low molecular weight aliphatic diisocyanates having a molar mass of 140 to 278 g/mol and/or hydrophilic polyisocyanates E) obtainable by reaction of
low molecular weight aliphatic diisocyanates E1) having a molar mass of 140 to 278 g/mol and/or polyisocyanates obtainable therefrom with an isocyanate functionality of 2 to 6, with
monofunctional polyalkylene oxides E2) having an OH number of 10 to 250 and an ethylene oxide fraction of 50 to 100 mol %, based on the total amount of oxyalkylene groups present.

The increased isocyanate group content due to the use of components D) and/or E) ensures better foaming, since the isocyanate-water reaction produces a larger amount of the CO₂ which acts as blowing agent.

It is also preferable for just heterocyclic 4-ring oligomers to be mixed with the prepolymers.

The optional compounds of component D) are heterocyclic 4-ring or 6-ring oligomers of low molecular weight aliphatic diisocyanates having a molar mass of 140 to 278 g/mol such as isocyanurates, iminooxadiazinediones or uretdiones of the aforementioned low molecular weight aliphatic diisocyanates. Heterocyclic 4-ring oligomers such as uretdiones are preferred.

The hydrophilic polyisocyanates E) are typically prepared by reacting 1 mol of OH groups of the monofunctional polyalkylene oxide component E2) with 1.25 to 15 mol, preferably with 2 to 10 mol and more preferably with 2 to 6 mol of NCO groups of a polyisocyanate E1) having an isocyanate functionality of 2 to 6, based on aliphatic diisocyanates. Exemplary of such polyisocyanates E1) are biuret structures, isocyanurates/uretdiones based on aliphatic diisocyanates. The polyisocyanate E1) and the polyalkylene oxide E2) are preferably linked together via a urethane group or a urea group, although particularly the linking via urethane groups is preferable.

The reaction can be carried out in the presence of urethanization catalysts such as tin compounds, zinc compounds, amines, guanidines or amidines, or in the presence of allophanatization catalysts such as zinc compounds.

The reaction temperature is typically in the range from 25 to 140° C. and preferably in the range from 60 to 100° C.

When excess low molecular weight diisocyanate was used, excess low molecular weight aliphatic diisocyanate is subsequently removed, preferably by thin film distillation.

Before, during and after the reaction or distillative removal of excess diisocyanate, acidic or alkylating stabilizers, such as benzoyl chloride, isophthaloyl chloride, methyl tosylate, chloropropionic acid, HCl or antioxidants, such as di-tert-butylcresol or tocopherol can be added.

The NCO content of hydrophilic polyisocyanates E) is preferably in the range from 0.3 to 20 wt %, more preferably in the range from 2 to 10 wt % and most preferably in the range from 3 to 6 wt %.

Examples of low molecular weight aliphatic diisocyanates of component E1) are hexamethylene diisocyanate (HDI), isophorone diisocyanate (IPDI), butylene diisocyanate (BDI), bisisocyanatocyclohexylmethane (HMDI), 2,2,4-trimethylhexamethylene diisocyanate, bisisocyanatomethylcyclohexane, bisisocyanatomethyltricyclodecane, xylene diisocyanate, tetramethylxylylene diisocyanate, norbornane diisocyanate, cyclohexane diisocyanate or diisocyanatododecane, of which hexamethylene diisocyanate (HDI), isophorone diisocyanate (IPDI), butylene diisocyanate (BDI) and bis(isocyanatocyclohexyl)methane (HMDI) are preferable. Hexamethylene diisocyanate, isophorone diisocyanate, butylene diisocyanate are more preferable and hexamethylene diisocyanate and isophorone diisocyanate are most preferable.

Examples of comparatively high molecular weight polyisocyanates E2) are polyisocyanates having an isocyanate functionality of 2 to 6 with isocyanurate, urethane, allophanate, biuret, iminooxadiazinetrione, oxadiazinetrione and/or uretdione groups based on the aliphatic and/or cycloaliphatic diisocyanates mentioned in the preceding section.

Preference for use as component E2) is given to comparatively high molecular weight compounds with biuret, iminooxadiazinedione, isocyanurate and/or uretdione groups based on hexamethylene diisocyanate, isophorone diisocyanate and/or 4,4′-diisocyanatodicyclohexylmethane. Isocyanurates are more preferable. Structures based on hexamethylene diisocyanate are most preferable.

The monofunctional polyalkylene oxides E2) have an OH number of 15 to 250 and preferably of 28 to 112 and an ethylene oxide fraction of 50 to 100 mol % and preferably of 60 to 100 mol %, based on the total amount of oxyalkylene groups present.

Monofunctional polyalkylene oxides for the purposes of the invention are compounds having just one isocyanate-reactive group, i.e., a group capable of reacting with an NCO group.

Preparing polyalkylene oxides E2) by alkoxylating suitable starter molecules is literature known (e.g., Ullmanns Encyclopadie der technischen Chemie, 4th edition, volume 19, Verlag Chemie, Weinheim pp. 31-38). Suitable starter molecules are especially saturated monoalcohols such as methanol, ethanol, n-propanol, isopropanol, n-butanol, isobutanol, sec-butanol, diethylene glycol monobutyl ether and also aromatic alcohols such as phenol or monoamines such as diethylamine. Preferred starter molecules are saturated monoalcohols of the aforementioned kind. It is particularly preferable to use diethylene glycol monobutyl ether or n-butanol as starter molecules.

The number-average molecular weights of the monofunctional polyalkylene oxides E2) are typically in the range from 220 to 3700 g/mol and preferably in the range from 500 to 2800 g/mol.

The monofunctional polyalkylene oxides E2) preferably have an OH group as isocyanate-reactive group.

In a further possible embodiment, the mixture of step III) optionally contains catalysts F), surfactants G), alcohols H) and/or blowing agents J).

To speed urethane formation, catalysts F) can be used. The catalysts in question are typically compounds with which a person skilled in the art is familiar from polyurethane technology. Preference here is given to compounds from the group consisting of catalytically active metal salts, amines, amidines and guanidines.

Specific examples are dibutyltin dilaurate (DBTL), tin octoate (SO), tin acetate, zinc octoate (ZO), 1,8-diazabicyclo[5.4.0]undecene-7 (DBU), 1,5-diazabicyclo-[4.3.0]nonene-5 (DBN), 1,4-diazabicyclo[3.3.0]octene-4 (DBO), N-ethylmorpholine (NEM), triethylenediamine (DABCO), pentamethylguanidine (PMG), tetramethylguanidine (TMG), cyclotetramethylguanidine (TMGC), n-decyltetramethylguanidine (TMGD), n-dodecyltetramethylguanidine (TMGDO), dimethylaminoethyltetramethylguanidine (TMGN), 1,1,4,4,5,5-hexamethylisobi-guanidine (HMIB), phenyltetramethylguanidine (TMGP) and hexamethyleneoctamethylbiguanidine (HOBG).

Catalysts F) can be especially metal salts, amines, amidines and guanidines used alone or in combination.

Compounds of component G) can be used to improve foam formation, foam stability or the properties of the resulting polyurethane foam, in which case such additives can in principle be any anionic, cationic, amphoteric and nonionic surfactants known per se and also mixtures thereof Preference is given to using alkylpolyglycosides, EO-PO block copolymers, alkyl or aryl alkoxylates, siloxane alkoxylates, esters of sulfosuccinic acid and/or. Particular preference is given to using EO-PO block copolymers. Preferably, the EO-PO block copolymers are solely used as component G).

In addition, compounds of component H) can be used to improve the foam properties of the resulting polyurethane foam. These compounds comprise in principle any mono- and polyhydric alcohols known per se to a person skilled in the art, and also mixtures thereof These are mono- or polyhydric alcohols or polyols, such as ethanol, propanol, butanol, decanol, tridecanol, hexadecanol, ethylene glycol, neopentyl glycol, butanediol, hexanediol, decanediol, trimethylolpropane, glycerol, pentaerythritol, monofunctional polyether alcohols and polyester alcohols, polyether diols and polyester diols.

Foaming can in principle be effected by means of the carbon dioxide formed in the course of the reaction of the isocyanate groups with water, but the use of further blowing agents J) is likewise possible. It is thus also possible in principle to use blowing agents from the class of the hydrocarbons such as C₃-C₆ alkanes, for example butanes, n-pentane, isopentane, cyclopentane, hexanes or the like, or halogenated hydrocarbons such as dichloromethane, dichloromonofluoromethane, chlorodifluoroethanes, 1,1-dichloro-2,2,2-trifluoroethane, 2,2-dichloro-2-fluoro-ethane, particularly chlorine-free hydrofluorocarbons such as difluoromethane, trifluoromethane, difluoroethane, 1,1,1,2-tetrafluoroethane, tetrafluoroethane (R 134 or R 134a), 1,1,1,3,3-pentafluoropropane (R 245 fa), 1,1,1,3,3,3-hexafluoropropane (R 256), 1,1,1,3,3-pentafluorobutane (R 365 mfc), heptafluoropropane, or else sulfur hexafluoride. Mixtures of these blowing agents can also be used.

In a preferred embodiment of the invention, the components A) to H) are used in the following amounts:

Typically, the components A) to H) are used in the following amounts:
100 parts by weight of isocyanate-functional prepolymers A),
0.1 to 5 parts by weight of C8- to C22-monocarboxylic acids or their ammonium or alkali metal salts or C12- to C44-dicarboxylic acids or their ammonium or alkali metal salts B),
1 to 200 parts by weight of water C),
0 to 100 parts by weight of heterocyclic oligomers D),
0 to 250 parts by weight of hydrophilic polyisocyanate component E),
0 to 1 part by weight of catalysts F),
0 to 10 parts by weight of surfactants G),
0 to 20 parts by weight of alcohols H).

Particular preference is given to using components A) to H) in the following amounts:
100 parts by weight of isocyanate-functional prepolymers A),
0.1 to 5 parts by weight of C8- to C22-monocarboxylic acids or their ammonium or alkali metal salts or C12- to C44-dicarboxylic acids or their ammonium or alkali metal salts B),
2 to 100 parts by weight of water C),
0 to 100 parts by weight of heterocyclic oligomers D),
5 to 250 parts by weight of hydrophilic polyisocyanate component E),
0 to 1 part by weight of catalysts F),
0 to 10 parts by weight of surfactants G),
0 to 20 parts by weight of alcohols H).

Very particular preference is given to using components A) to H) in the following amounts:
100 parts by weight of isocyanate-functional prepolymers A),
0.1 to 5 parts by weight of C8- to C22-monocarboxylic acids or their ammonium or alkali metal salts or C12- to C44-dicarboxylic acids or their ammonium or alkali metal salts B),
5 to 50 parts by weight of water C),
5 to 50 parts by weight of heterocyclic oligomers D),
10 to 50 parts by weight of hydrophilic polyisocyanate component E),
0 to 1 part by weight of catalysts F),
0 to 10 parts by weight of surfactants G),
0 to 20 parts by weight of alcohols H).

Temperatures for commixing the components and/or mixtures and during the foaming reaction can be in the range from 0 to 100° C., preferably at from 15 to 70° C. and most preferably at from 20 to 50° C.

After mixing the component, the mixture is applied to a sheetlike substrate as a layer of constant thickness. Examples of suitable substrates are release foils or release papers, which may likewise be in an apertured state.

It may be preferable to apply the mixture to the substrate by blade coating. For this, the mixture may be poured into a blade-coating box and be blade-coated horizontally in a certain thickness in sheetlike mats onto a suitable substrate such as, for example, a release foil or a release paper.

Blade gap height is generally in the range from 0.2 to 20 mm, preferably in the range from 0.2 to 5 mm and most preferably in the range from 0.2 to 2 mm. The film width of the blade to be used can be conformed to the particular intended purpose. Examples are film widths between 10 and 5000 mm and preferably between 10 and 4000 mm.

Any known type of blade coater can be used, for example a floating knife coater, a knife-on-roll coater, a spreading-blade coater, a box-type blade coater, a blade-knife coater or a magnetic squeegee coater. Any customary material can be used for the blade, for example metals such as stainless steel or plastics. A composite of two or more materials can also be used to produce the blade. Both manual coaters and machine coaters can be used, preference being given to the use of machine coaters as part of suitable coating rigs. Application between rolls is another possibility.

Directly after application, an apertured release element is placed sheetlike on the layer of the mixture, so that it covers the substrate-remote surface of the layer.

Apertured herein is understood as referring to a release element which has a multiplicity of apertures extending from the contact face through the release element.

The apertures preferably have a circular diameter.

It is also preferable for the apertures to form a uniform distribution across the release element.

The apertures may preferably have a diameter of 20 to 300 μm. This provides foams with no visible elevations on the surface of the foam in the shape of the release element apertures. The foams have a smooth surface, as is particularly advantageous for their use as wound dressing, since wound dressings shall ideally conform to the body sheetlike.

The separation between two adjacent apertures is preferably between 0.1 to 5 mm, more preferably between 0.5 to 3 mm and most preferably between 0.8 and 2.5 mm.

The apertured release element may be for example an apertured release paper or an apertured release foil. The release paper may be, for example, siliconized paper, polyolefin-coated paper or fluorocarbon-coated paper. Similarly, the release foil may consist of silicone, polyolefins and/or fluorocarbon and/or be coated with materials of this type.

After the release element has been applied, it may more particularly be preferable to apply a defined downward pressure on the layer composed of the mixture of step III).

To speed the curing of the polyurethane foam on completion of its expansion, it can be heated. It may be preferable to heat the polyurethane foam to a temperature of 40 and 140° C., more preferably of 60 to 120° C. and even more preferably of 60 to 110° C.

Particular preference is also given to a process wherein a wound dressing is produced from the polyurethane foam of the present invention.

Further subjects of the invention are a polyurethane foam obtainable according to the method of the present invention.

The polyurethane foams obtained have a porous, at least partially open-cell structure having intercommunicating cells. The density of the polyurethane foams is typically in the range from 0.01 to 0.6 g/cm³, preferably in the range from 0.02 to 0.85 g/cm³, more preferably in the range from 0.05 to 0.4 g/cm³ and most preferably in the range from 0.1 to 0.3 g/cm³ (determined according to DIN 53420).

The polyurethane foams may be adhered to or laminated or coated with further materials, for example materials based on hydrogels, (semi)permeable films, foam films, coatings, hydrocolloids or other foams.

The polyurethane foams of the present invention are particularly useful in the manufacture of wound dressings. In these dressings, the polyurethane foams can be in direct or indirect contact with the wound. Preferably, however, the polyurethane foams are used in direct contact with the wound in order that optimum absorbance of wound fluid may be ensured for example. The polyurethane foams exhibit no cytotoxicity (determined according to ISO 10993-5 and ISO 10993-12).

The polyurethane foams which are used as wound dressing can be additionally sterilized in a further operation. The sterilization is effected using processes known per se to a person skilled in the art, wherein sterilization is effected by thermal treatment, chemical substances such as ethylene oxide or irradiation, for example by gamma irradiation. Irradiation here may be carried out under protective gas atmosphere, where appropriate. The polyurethane foams of the present invention here have the immense advantage of not discoloring on irradiation, in particular on irradiation with gamma rays.

It is likewise possible to add, incorporate or coat antimicrobially or biologically active components which have a positive effect for example in relation to wound healing and the avoidance of germ loads.

The invention finally also provides a sheetlike hydrophilic aliphatic polyurethane foam of the present invention for use as wound dressing, incontinence product or cosmetic article.

### EXAMPLES

Unless stated otherwise, all percentages are by weight. Solids contents were determined according to DIN-EN ISO 3251. Viscosities were determined at 23° C. to DIN 53019. NCO contents were determined volumetrically in accordance with DIN-EN ISO 11909.

The blade coater used was a Zehntner ZUA 2000 universal applicator having a film width of 200 mm and a gap height adjustable from 0 to 3 mm (from Zehntner GmbH, Sissach, Switzerland).

Substances and Abbreviations Used:
Desmodur® N 3400: aliphatic polyisocyanate (HDI uretdione), NCO content 21.8%
Desmodur° N 3300: aliphatic polyisocyanate (HDI isocyanurate), NCO content 21.8%, Bayer MaterialScience AG, Leverkusen, Germany

### Example 1

### Preparing Polyurethane Prepolymer 1

To a mixture of 1000 g of hexamethylene diisocyanate (HDI) and 1 g of benzoyl chloride, 1000 g of a glycerol-started polyalkylene oxide having a molar mass of 4680 g/mol, an ethylene oxide weight fraction of 72% and a propylene oxide weight fraction of 28%, which had been dried beforehand at 100° C. for 6 h at a pressure of 0.1 mbar, were added by dropwise addition at 80° C. in the course of 3 h and subsequently stirred for 12 h. Excess HDI was removed by thin film distillation at 130° C. and 0.1 mbar, while the non-volatile constituents were stabilized with 1 g of chloropropionic acid to obtain a prepolymer having an NCO content of 2.77% and a viscosity of 3500 mPas.

### Example 2

### Preparing the Hydrophilicized Polyisocyanates

A mixture of 282.5 g of Desmodur N 3300 and 843.8 g of a hydroxyl-monofunctional polyether based on ethylene oxide/propylene oxide (having an ethylene oxide content of 80 mol based on the total amount of oxyalkylene groups present), number average molecular weight 2250 g/mol (OH number 25 mg KOH/g) was stirred in a glass apparatus at 80° C. until the DIN-EN ISO 11909 titrimetrically determined NCO group content was constant. This gave a liquid having an NCO content of 4.04% and a viscosity of 3330 mPas.

### Examples 3-10, Comparative Examples 11-15

### Production of Foams from Polyurethane Prepolymers 1

The isocyanate components, the prepolymer, Desmodur N3400 and the hydrophilicized polyisocyanate were homogenized in a 250 ml capacity beaker at a stirrer speed of 1200 rpm for 15 seconds. The further components were weighed into a second beaker and stirred together therein for 10 seconds. The contents of the two beakers were then combined and commixed. The mixture thus obtained was blade coated sheetlike onto a release paper using a ZUA 2000 blade coater at a gap height of 1.5 mm Immediately after blade coating, an apertured release paper was placed on the layer of the still wet sheetlike reaction mixture. The foam was then cured at 100° C. within 5 minutes.

Overview of Release Papers Used:
A: apertured siliconized release paper K900 ecru matte, 51BU/51B4 (from Laufenberg), hole size 110 μm, hole separation 1 mm
B: apertured PE-coated release paper Y5200 (from Felix Schöller), hole size 120 μm, hole separation 2 mm
C: apertured siliconized release paper KS 1200 white 51B (from Laufenberg), hole size 235 μm, hole separation 2 mm
D: apertured siliconized release paper 2CC 130/1 (from Cotek), hole size 100 μm, hole separation 2 mm
E: apertured siliconized release paper 2CC 130/1 (from Cotek), hole size 265 μm, hole separation 2 mm
F: apertured PE-coated release paper Y5200 (from Felix Schöller), hole size 1000 μm, hole separation 10 mm
G: apertured PE-coated release paper Y5200 (from Felix Schöller), hole size 400 μm, hole separation 10 mm
H: apertured PE-coated release paper Y5200 (from Felix Schöller), hole size 400 μm, hole separation 5 mm
I: siliconized release paper K900 ecru matte, 51BU/51B4 (from Laufenberg) without aperturing
J: PE-coated release paper Y5200 (from Felix Schöller) without aperturing
K: siliconized release paper KS 1200 white 51B (from Laufenberg) without 2 5 aperturing
L: siliconized release paper 2CC 130/1 (from Cotek) without aperturing
M: siliconized release paper 2CC 130/1 (from Cotek) without aperturing

| | | | | | | | | | Compar- | Compar- | Compar- | Compar- | Compar- |
|---|---|---|---|---|---|---|---|---|---|---|---|---|---|
| | | | | | | | | | ative | ative | ative | ative | ative |
| Component | Example | Example | Example | Example | Example | Example | Example | Example | Example | Example | Example | Example | Example |
| [g] | 3 | 4 | 5 | 6 | 7 | 8 | 9 | 10 | 11 | 12 | 13 | 14 | 15 |
| prepolymer | 100 | 100 | 100 | 100 | 100 | 100 | 100 | 100 | 100 | 100 | 100 | 100 | 100 |
| hydrophilicized | 25 | 25 | 25 | 25 | 25 | 25 | 25 | 25 | 25 | 25 | 25 | 25 | 25 |
| PIC | | | | | | | | | | | | | |
| Desmodur | 11.1 | 11.1 | 11.1 | 11.1 | 11.1 | 11.1 | 11.1 | 11.1 | 11.1 | 11.1 | 11.1 | 11.1 | 11.1 |
| N3400 | | | | | | | | | | | | | |
| sodium oleate | 11.1 | 11.1 | 11.1 | 11.1 | 11.1 | 11.1 | 11.1 | 11.1 | 11.1 | 11.1 | 11.1 | 11.1 | 11.1 |
| 5% in water | | | | | | | | | | | | | |
| water | 4.7 | 4.7 | 4.7 | 4.7 | 4.7 | 4.7 | 4.7 | 4.7 | 4.7 | 4.7 | 4.7 | 4.7 | 4.7 |
| blade gap (mm) | 1.5 | 1.5 | 1.5 | 1.5 | 1.5 | 1.5 | 1.5 | 1.5 | 1.5 | 1.5 | 1.5 | 1.5 | 1.5 |
| release paper | A | B | C | D | E | F | G | H | I | J | K | L | M |

Inventive Examples 3 to 10 give foams having a homogeneous, skinless, smooth surface, which have a very soft feel and possess good drapability on the skin. However, the foams of Examples 8 to 10 had visible elevations on the foam surface in the shape of the release paper apertures. Therefore, the surfaces of the foams were not completely smooth.

Comparative Examples 11 to 15 (covering with nonapertured release papers) gave foams having an inhomogeneous surface with many large holes and voids and a stiff skin.

1-17. (canceled)

18. A method for producing a sheetlike hydrophilic aliphatic polyurethane foam which comprises
I) preparing an isocyanate-functional prepolymer A) by reacting
a low molecular weight aliphatic diisocyanate A1) having a molar mass of 140 to 278 g/mol with
a di- to hexafunctional polyalkylene oxide A2) having an OH number of 22.5 to 112 mg KOH/g and an ethylene oxide fraction of 50 to 100 mol %, based on the total amount of oxyalkylene groups present,
II) mixing C8- to C22-monocarboxylic acid or their ammonium or alkali metal salt or C12- to C44-dicarboxylic acid or their ammonium or alkali metal salt B) with water C),
III) combining and commixing the mixtures of steps I) and II),
IV) applying the mixture of step III) to a sheetlike substrate as a layer of constant thickness,
V) applying an apertured release element to the layer of step IV) in a sheetlike manner, so that the substrate-remote surface of the layer is covered, and
VI) expanding the layer of step V) to the foam to be produced.

19. The method of claim 18, wherein the prepolymer A) is mixed in step I) with a heterocyclic 4-ring or 6-ring oligomer D) of low molecular weight aliphatic diisocyanate having a molar mass of 140 to 278 g/mol and/or hydrophilic polyisocyanate E) obtained by reacting
a low molecular weight aliphatic diisocyanate E1) having a molar mass of 140 to 278 g/mol and/or polyisocyanate obtained therefrom with an isocyanate functionality of 2 to 6, with
a monofunctional polyalkylene oxide E2) having an OH number of 10 to 250 and an ethylene oxide fraction of 50 to 100 mol %, based on the total amount of oxyalkylene groups present.

20. The method of claim 18, wherein the apertured release element is a release paper or a release foil.

21. The method of claim 20, wherein the release element is at least one of siliconized paper, polyolefin coated paper, fluorocarbon paper, silicone foil, polyolefin foil, fluorocarbon foil or coated foil.

22. The method of claim 18, wherein the apertured release element has a circular aperture having a diameter of 20 to 300 μm.

23. The method of claim 22, wherein the separation between two adjacent circular apertures is between 0.1 to 5 mm.

24. The method of claim 22, wherein the separation between two adjacent circular apertures is between 0.8 and 2.5 mm.

25. The method of claim 18, wherein the NCO content of the isocyanate-functional prepolymer A) is 1.5 to 3.0 weight %.

26. The method of claim 18, wherein the diisocyanate A1) is hexamethylene diisocyanate, isophorone diisocyanate or a mixture thereof.

27. The method of claim 18, wherein the polyalkylene oxide A2) is a copolymer of ethylene oxide and propylene oxide having an ethylene oxide content, based on the total amount of oxyalkylene groups present, of 60 to 85 mol %.

28. The method of claim 18, wherein the polyalkylene oxide A2) has a number-average molecular weight of 3000 to 8500 g/mol.

29. The method of claim 18, wherein the polyalkylene oxide A2) has OH functionalities of 3 to 4.

30. The method of claim 18, wherein the mixture of step III) contains a catalyst F), a surfactant G), an alcohol H) and/or a blowing agent I).

31. The method of claim 30, wherein the catalyst F) is metal salt, amine, amidine, guanidine or a mixture thereof.

32. The method of claim 30, wherein the components A) to H) are used in the following amounts:
100 parts by weight of isocyanate-functional prepolymer A),
0.1 to 5 parts by weight of C8- to C22-monocarboxylic acid or their ammonium or alkali metal salt or C12- to C44-dicarboxylic acid or their ammonium or alkali metal salt B),
1 to 200 parts by weight of water C),
0 to 100 parts by weight of heterocyclic oligomer D),
0 to 250 parts by weight of hydrophilic polyisocyanate component E),
0 to 1 part by weight of catalyst F),
0 to 10 parts by weight of surfactant G), and
0 to 20 parts by weight of alcohol H).

33. The method of claim 18, wherein the polyurethane foam on completion of expansion is heated to speed curing.

34. The method of claim 33, wherein the polyurethane foam on completion of expansion is heated to a temperature of 40 to 140° C.

35. The method of claim 33, wherein the polyurethane foam on completion of expansion is heated to a temperature of 60 to 110° C.

36. The method of claim 18, wherein a wound dressing is produced from the polyurethane foam.

37. A sheetlike hydrophilic aliphatic polyurethane foam obtained by the method of claim 18.

38. The sheetlike hydrophilic aliphatic polyurethane foam of claim 37, wherein the foam is a wound dressing, an incontinence product or a cosmetic article.

39. A wound dressing, an incontinence product or a cosmetic article which comprises the hydrophilic aliphatic polyurethane foam of claim 37.
